(19) United States
(12) Patent Application Publication
(10) Pub. No.: US 2003/0018781 A1
(43) Pub. Date: Jan. 23, 2003

(54) Method and system for an interconnection network to support communications among a plurality of heterogeneous processing elements

(76) Inventor: W. James Scheuermann, Saratoga, CA (US)

Correspondence Address: Joseph A. Sawyer, Jr., SAWYER LAW GROUP LLP, P.O. Box 51418, Palo Alto, CA, 94303, US

(21) Appl. No.: 09/898,350

(22) Filed: Jul. 3, 2001

(51) Int. Cl. G06F 15/173

(52) U.S. Cl. 709/225

(57) ABSTRACT

Aspects of a method and system for supporting communication among a plurality of heterogeneous processing elements of a processing system are described. The aspects include an interconnection network that supports services between any two processing nodes within a plurality of processing nodes. A predefined data word format is utilized for communication among the plurality of processing nodes on the interconnection network, the predefined data word format indicating a desired service. Further, arbitration occurs among communications in the network to ensure fair access to the network by each processing node.

### FIELD OF THE INVENTION

The present invention relates to communications among a plurality of processing elements and an interconnection network to support such communications.

### BACKGROUND OF THE INVENTION

The electronics industry has become increasingly driven to meet the demands of high-volume consumer applications, which comprise a majority of the embedded systems market. Embedded systems face challenges in producing performance with minimal delay, minimal power consumption, and at minimal cost. As the numbers and types of consumer applications where embedded systems are employed increases, these challenges become even more pressing. Examples of consumer applications where embedded systems are employed include handheld devices, such as cell phones, personal digital assistants (PDAs), global positioning system (GPS) receivers, digital cameras, etc. By their nature, these devices are required to be small, low-power, light-weight, and feature-rich.

In the challenge of providing feature-rich performance, the ability to produce efficient utilization of the hardware resources available in the devices becomes paramount. As in most every processing environment that employs multiple processing elements, whether these elements take the form of processors, memory, register files, etc., of particular concern is coordinating the interactions of the multiple processing elements. Accordingly, what is needed is a manner of networking multiple processing elements in an arrangement that allows fair and efficient communication in a point-to-point fashion to achieve an efficient and effective system. The present invention addresses such a need.

### SUMMARY OF THE INVENTION

Aspects of a method and system for supporting communication among a plurality of heterogeneous processing elements of a processing system are described. The aspects include an interconnection network that supports services between any two processing nodes within a plurality of processing nodes. A predefined data word format is utilized for communication among the plurality of processing nodes on the interconnection network, the predefined data word format indicating a desired service. Further, arbitration occurs among communications in the network to ensure fair access to the network by each processing node.

With the aspects of the present invention, multiple processing elements are networked in an arrangement that allows fair and efficient communication in a point-to-point manner to achieve an efficient and effective system. These and other advantages will become readily apparent from the following detailed description and accompanying drawings.

### BRIEF DESCRIPTION OF THE DRAWINGS

FIG. 1 is a block diagram illustrating an adaptive computing engine.

FIG. 2 illustrates a representation of a processing node interconnection network in accordance with the present invention.

FIG. 3 illustrates a data structure for communications on the interconnection network in accordance with a preferred embodiment of the present invention.

FIG. 4 illustrates a block diagram of logic included in the interconnection network to support communications among the nodes in accordance with a preferred embodiment of the present invention.

### DETAILED DESCRIPTION OF THE INVENTION

The present invention relates to communications support among a plurality of processing elements in a processing system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In a preferred embodiment, the aspects of the present invention are provided in the context of an adaptable computing engine in accordance with the description in co-pending U.S. patent application Ser. No. ______, entitled “______”, assigned to the assignee of the present invention and incorporated by reference in its entirety herein. Portions of that description are reproduced hereinbelow for clarity of presentation of the aspects of the present invention.

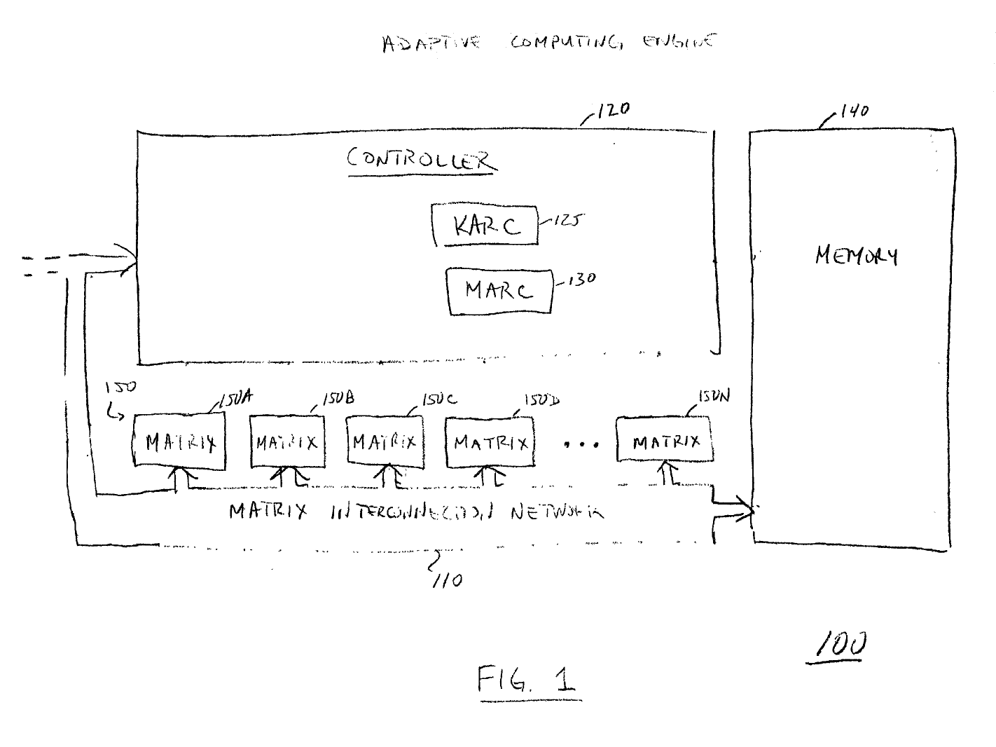

Referring to FIG. 1, a block diagram illustrates an adaptive computing engine (“ACE”) 100, which is preferably embodied as an integrated circuit, or as a portion of an integrated circuit having other, additional components. In the preferred embodiment, and as discussed in greater detail below, the ACE 100 includes a controller 120, one or more reconfigurable matrices 150, such as matrices 150A through 150N as illustrated, a matrix interconnection network 110, and preferably also includes a memory 140.

The controller 120 is preferably implemented as a reduced instruction set (“RISC”) processor, controller or other device or IC capable of performing the two types of functionality. The first control functionality, referred to as “kernal” control, is illustrated as kernal controller (“KARC”) 125, and the second control functionality, referred to as “matrix” control, is illustrated as matrix controller (“MARC”) 130.

The various matrices 150 are reconfigurable and heterogeneous, namely, in general, and depending upon the desired configuration: reconfigurable matrix 150A is generally different from reconfigurable matrices 150B through 150N; reconfigurable matrix 150B is generally different from reconfigurable matrices 150A and 150C through 150N; reconfigurable matrix 150C is generally different from reconfigurable matrices 150A, 150B and 150D through 150N, and so on. The various reconfigurable matrices 150 each generally contain a different or varied mix of computation units, which in turn generally contain a different or varied mix of fixed, application specific computational elements, which may be connected, configured and reconfigured in various ways to perform varied functions, through the interconnection networks. In addition to varied internal configurations and reconfigurations, the various matrices 150 may be connected, configured and reconfigured at a higher level, with respect to each of the other matrices 150, through the matrix interconnection network (MIN) 110.

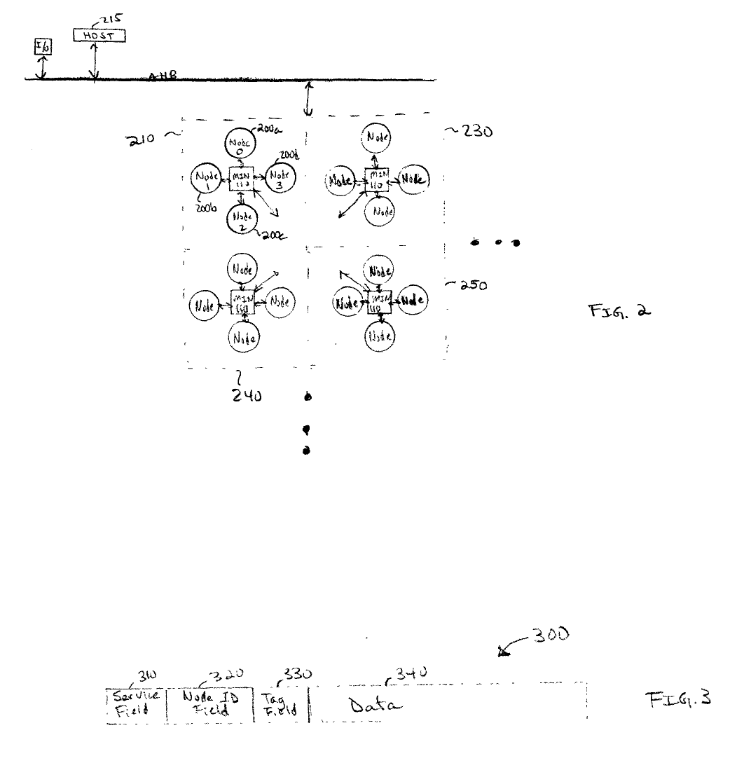

In accordance with the present invention, the MIN 110 provides a foundation that allows a plurality of heterogeneous processing nodes, e.g., matrices 150, to communicate by providing a single set of wires as a homogeneous network to support plural services, these services including DMA (direct memory access) services, e.g., Host DMA (between the host processor and a node), and Node DMA (between two nodes), and read/write services, e.g., Host Peek/Poke (between the host processor and a node), and Node Peek/Poke (between two nodes). In a preferred embodiment, the plurality of heterogeneous nodes are organized in a manner that allows scalability and locality of reference while being fully connected via the MIN 110. By way of example, a quad arrangement of nodes, as shown in FIG. 2, organizes four nodes, 200a, 200b, 200c, and 200d, e.g., three matrices and a RISC, as a grouping 210 for communicating in a point-to-point manner via the MIN 110. The MIN 110 further supports communication between the grouping 210 and a processing entity external to the grouping 210, such as a host processor 215 connected by a system bus. In a preferred embodiment, the organization of nodes as a grouping 210 can be altered to include a different number of nodes and can be duplicated as desired to interconnect multiple sets of groupings, e.g., groupings 230, 240, and 250, where each set of nodes communicates within their grouping and among the sets of groupings via the MIN 110.

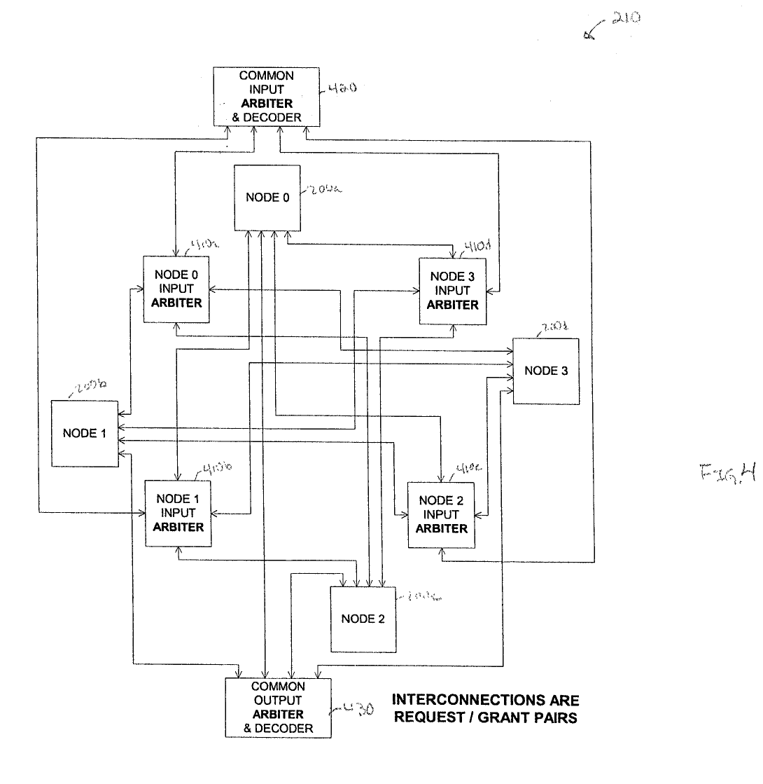

In a preferred embodiment, a data structure as shown in FIG. 3 is utilized to support the communications among the nodes 200 via the MIN 110. The data structure preferably comprises a multi-bit data word 300, e.g., a 30 bit data word, that includes a service field 310 (e.g., a 4-bit field), a node identifier field 320 (e.g., a 6-bit field), a tag field 330 (e.g., a 4-bit tag field), and a data/payload field 340 (e.g., a 16-bit data field), as shown. Thus, the data word 300 specifies the type of operation desired, e.g., a node write operation, the destination node of the operation, e.g., the node whose memory is to be written to, a specific entity within the node, e.g., the input channel being written to, and the data, e.g., the information to be written in the input channel of the specified node. The MIN 110 exists to support the services indicated by the data word 300 by carrying the information under the direction, e.g., “traffic cop”, of arbiters at each point in the network of nodes.

Thus, for an instruction in a source node, a request for connection to a destination node is generated via generation of a data word. Referring now to FIG. 4, for each node 200 in a grouping 210, a token-based, round robin arbiter 410 is implemented to grant the connection to the requesting node 200. The token-based, round robin nature of arbiter 410 enforces fair, efficient, and contention-free arbitration as priority of network access is transferred among the nodes, as is standardly understood by those skilled in the art. Of course, the priority of access can also be tailored to allow specific services or nodes to receive higher priority in the arbitration logic, if desired. For the quad node embodiment, the arbiter 410 provides one-of-four selection logic, where three of the four inputs to the arbiter 410 accommodate the three peer nodes 200 in the arbitrating node's quad, while the fourth input is provided from a common input with arbiter and decoder logic 420. The common input logic 420 connects the grouping 210 to inputs from external processing nodes. Correspondingly, for the grouping 210 illustrated, its common output arbiter and decoder logic 430 would provide an input to another grouping's common input logic 420. It should be appreciated that although single, double-headed arrows are shown for the interconnections among the elements in FIG. 4, these arrows suitably represent request/grant pairs to/from the arbiters between the elements, as is well appreciated by those skilled in the art.

In the present invention, a plurality of heterogeneous processing elements provide a flexible and adaptable system. The system scales to any number of nodes. The interconnections among the elements is realized utilizing a straightforward and effective point-to-point network, allowing any node to communicate with any other node efficiently. In addition, for n nodes, the system supports n simultaneous transfers. A common data structure and use of arbitration logic provides consistency and order to the communications on the network.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. A method for supporting communication among a plurality of heterogeneous processing elements of a processing system, the method comprising:
forming an interconnection network to support services between any two processing nodes within a plurality of processing nodes;
utilizing a predefined data word format for communication among the plurality of processing nodes on the interconnection network, the predefined data word format indicating a desired service; and
arbitrating among communications in the network to ensure fair access to the network by each processing node.

2. The method of claim 1 wherein forming an interconnection network further comprises forming connections between each node in a grouping of nodes and between each of a plurality of groupings.

3. The method of claim 2 wherein the grouping of nodes further comprises a grouping of four nodes.

4. The method of claim 3 further comprising utilizing a matrix element as a processing node.

5. The method of claim 4 further comprising utilizing a RISC element as a processing node.

6. The method of claim 1 wherein forming an interconnection network further comprises forming a network of connections to support services in a point-to-point manner.

7. The method of claim 1 further comprising utilizing the interconnection network to support services between a node and a host processor external to the plurality of processing nodes.

8. The method of claim 7 wherein forming an interconnection network to support services further comprises forming an interconnection network to support a host DMA service, a node DMA service, a host read/write service, and a node read/write service.

9. The method of claim 1 wherein utilizing a predefined data word format further comprises utilizing a data word format that includes a service field, a node field, a tag field, and a data field.

10. The method of claim 9 wherein the data word format further comprises a 30-bit data word.

11. The method of claim 1 wherein arbitrating further comprises transferring priority of access to the interconnection network in a round-robin manner among the plurality of processing nodes.

12. A system for supporting communication among a plurality of processing elements, the system comprising
a plurality of heterogeneous processing nodes organized as a plurality of groupings;
an interconnection network for supporting data services within and among the plurality of groupings as indicated by a data word sent from one processing node to another; and
a plurality of arbiters for directing data word traffic on the interconnection network to allow fair and efficient utilization of the interconnection network by the plurality of heterogeneous processing nodes.

13. The method of claim 12 wherein each grouping in the plurality of groupings further comprises four processing nodes.

14. The system of claim 12 wherein the plurality of arbiters provide arbitration within and among each grouping in a token-based, round robin manner.

15. The system of claim 12 further comprising a matrix as a processing node type.

16. The system of claim 12 further comprising a RISC processor as a processing node type.

17. The system of claim 12 further comprising a host processor coupled to the plurality of heterogeneous processing nodes via the interconnection network.

18. The system of claim 12 wherein the data word further comprises a plurality of bits organized as a services field, a node identification field, a tag field, and a data field.

19. The system of claim 12 wherein the communications network supports DMA services and read/write services.

20. A method for supporting communications among a plurality of processing elements, the method comprising:
organizing a plurality of heterogeneous processing nodes as separate groups of processing nodes;
providing one set of wires to support a plurality of separate processing services among and within each separate group;
communicating a data word that indicates the desired processing service from one point to another point within the plurality of heterogeneous processing nodes via the set of wires.

21. The method of claim 20 wherein each separate group further comprises four nodes.

22. The method of claim 21 wherein the four nodes further comprise three matrix elements and a RISC element.

23. The method of claim 20 further comprising arbitrating within and among the separate groups of nodes for utilization of the set of wires.
